(19) United States
(12) Patent Application Publication
(10) Pub. No.: US 2011/0216389 A1
(43) Pub. Date: Sep. 8, 2011

(54) ELECTRICALLY CONTROLLABLE DEVICE HAVING A CONTROLLED THICKNESS OF AN ELECTROACTIVE MEDIUM AND THAT IS OF SIMPLIFIED MANUFACTURE AND MANUFACTURING PROCESS THEREOF

(75) Inventors: Fabienne Piroux, Compiegne (FR); Gilles Bokobza, Paris (FR)

(73) Assignee: SAINT-GOBAIN GLASS FRANCE, Courbevoie (FR)

(21) Appl. No.: 13/127,636

(22) PCT Filed: Dec. 1, 2009
(86) PCT No.: PCT/EP2009/066165

§ 371 Date: May 4, 2011

(30) Foreign Application Priority Data
Dec. 4, 2008 (FR) 0858280

(51) Int. Cl. G02F 1/153; B32B 37/02; B32B 37/14

(52) U.S. Cl. 359/268; 359/265; 359/275; 156/109

(57) ABSTRACT

This device comprises the following stack of layers: a substrate having a glass function (V₁); a first electronically conductive layer (TCC₁) with an associated current feed; a layer of electroactive varnish (VEA) based on at least one binder polymer containing the constituents of an electroactive medium that are formed by: at least one electroactive organic compound capable of being reduced and/or of accepting electrons and cations acting as compensation charges; at least one electroactive organic compound capable of being oxidized and/or of ejecting electrons and cations acting as compensation charges; at least one of said electroactive organic compounds being electrochromic in order to obtain a color contrast; and ionic charges capable of allowing, under an electric current, oxidation and reduction reactions of said electroactive organic compounds, which reactions are necessary to obtain the color contrast; and a second electronically conductive layer (TCC₂) with an associated current feed.

The present invention is an improvement to electrically controllable devices having variable optical/energy properties, comprising the following stack of layers:
a first substrate having a glass function (v₁);
a first electronically conductive layer (TCC₁) with an associated current feed;
an electroactive (ea) system comprising or constituted by:
   at least one electroactive organic compound (ea₁⁺) capable of being reduced and/or of accepting electrons and cations acting as compensation charges;
   at least one electroactive organic compound (ea₂) capable of being oxidized and/or of ejecting electrons and cations acting as compensation charges;
   at least one of said electroactive organic compounds (ea₁⁺ and ea₂) being electrochromic in order to obtain a color contrast; and
   ionic charges capable of allowing, under an electric current, oxidation and reduction reactions of said electroactive organic compounds (ea₁⁺ & ea₂), which reactions are necessary to obtain the color contrast;
a second electronically conductive layer (TCC₂) with an associated current feed; and
a second substrate having a glass function (v₂).

The electronically conductive layers are denoted by “TCC”, an abbreviation for “Transparent Conductive Coating”, an example of which is a TCO (“Transparent Conductive Oxide”).

If it is assumed that the compound (ea₁⁺) is electrochromic (being, for example, 1,1′-diethyl-4,4′-bipyridinium diperchlorate) and that the compound (ea₂) is electrochromic (being, for example, 5,10-dihydro-5,10-phenothiazine) or is not electrochromic (being, for example, a ferrocene), the redox reactions that are established under the action of the electric current are the following:

ea₁⁺+e⁻ [symbol] ea₁
Colored

ea₂ [symbol] ea₂⁺+e⁻
Colored if electrochromic
Colorless if not electrochromic

The electroactive medium (ea) is a medium that is in solution or that is gelled. It may also be contained in a self-supported polymer matrix such as is described in international application PCT/FR2008/051160 filed on 25, Jun. 2008 or in European application EP 1 786 883.

In the case where the medium (ea) is in solution or is gelled and therefore has no mechanical strength, it must be encapsulated in the “reservoir” zone delimited by the two glass sheets (v₁), (v₂), positioned facing one another with their inner surfaces each coated with the (TCC₁), (TCC₂) layer respectively, and with an electrically insulating encapsulating peripheral frame or seal. This reservoir zone is filled via an orifice made in this peripheral seal via a relatively complex technique under vacuum.

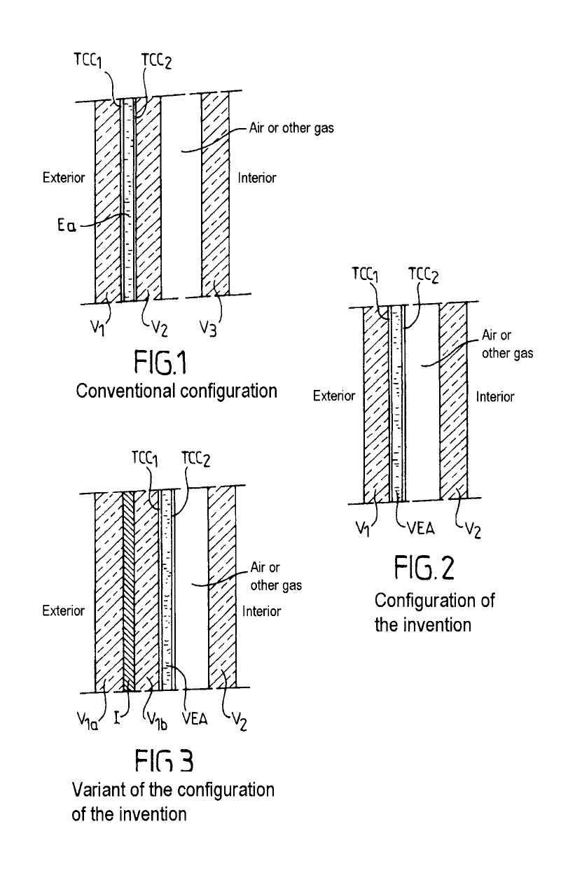

One particular application of such an electrically controllable device is the production of glazing units, and especially of double glazing units for buildings. FIG. 1 of the appended drawing schematically illustrates the configuration of such a double glazing unit, which comprises a third sheet of glass (v₃) opposite the sheet of glass (v₂), with interposition of an air-filled space or a space filled with another gas, such as argon, between the sheets (v₂) and (v₃), the peripheral seal (not represented) being suitable for supporting the assembly.

Due to the use of the aforementioned vacuum filling technique, it is therefore clear that it is not easy to manufacture such glazing units, a fortiori such double glazing units. It may even be said that it is practically impossible to adapt this technique to large-sized glazing units and double glazing units.

Furthermore, in the case of double glazing units for buildings in particular, the sheets of glass (v1) and (v2), located on the exterior side, must be made of toughened glass due to the thermal expansion coefficient of the glass. However, toughened glass has mini-defects in the flatness, which will result in a problem of uniformity of coloration during the operation of the electrically controllable device. Knowing that the electroactive medium in the liquid phase must allow the mobility of the electroactive species (ea1) and (ea2), (ea₁⁺) and (ea₂⁺), it must therefore have a certain thickness, which must also allow the filling operation and must furthermore be adjusted with precision in order to be thick enough to overcome the problems of non-uniformity of the coloration of the glazing, but not too thick in order not to impair the rapidity of this color change and also good visibility through the glazing. Such a thickness is in practice between 100 μm and 700 μm.

This flatness defect problem is also present in the case of flexible substrates made of organic glass, such as polyethylene terephthalate substrates.

It may also be noted that too great a thickness of the electroactive layer is not desired considering the risk of reduction of the value of the light transmission of the electroactive layer when no electric current is applied, thus reducing the desired contrast during the change in coloration.

The use of a self-supported polymer matrix as a container for the electroactive medium makes it possible to simplify the manufacture, since it permits the stacking of the various layers. However, the fact remains that its mechanical strength is not perfect and that, when it is applied between substrates that have mini-defects in the flatness such as flexible substrates and toughened glass, it will adopt these flatness defects. Since the entire thickness of the electroactive medium participates in the coloration, problems in the uniformity of this coloration will then arise. It is certainly possible to increase the thickness of the self-supported polymer matrix, but this is not ideal either for the same two reasons as those indicated above.

The applicant company has therefore sought to eliminate or to reduce at least one of these many drawbacks, and in particular it has sought means that make it possible to control the thickness of the active medium other than by controlling the distance between the two substrates, while seeking to simplify the process for manufacturing the electrically controllable device.

For this purpose, the applicant company has discovered that the electroactive medium could be deposited on a substrate coated with a first electronically conductive layer in the form of a varnish to be dried, the thickness of which is perfectly controlled, advantageously below that of the prior art, and which, once dried, has a sufficient mechanical strength to allow a direct deposition of the second electronically conductive layer.

A first subject of the present invention is therefore an electrically controllable device having variable optical/energy properties, characterized in that it comprises the following stack of layers:
a substrate having a glass function (V₁);
a first electronically conductive layer (TCC₁) with an associated current feed;
a layer of electroactive varnish (VEA) based on at least one binder polymer containing the constituents of an electroactive medium that are formed by:
   at least one electroactive organic compound (ea₁⁺) capable of being reduced and/or of accepting electrons and cations acting as compensation charges;
   at least one electroactive organic compound (ea₂) capable of being oxidized and/or of ejecting electrons and cations acting as compensation charges;
   at least one of said electroactive organic compounds (ea₁⁺ and ea₂) being electrochromic in order to obtain a color contrast; and
   ionic charges capable of allowing, under an electric current, oxidation and reduction reactions of said electroactive organic compounds (ea₁⁺ & ea₂), which reactions are necessary to obtain the color contrast; and
a second electronically conductive layer (TCC₂) with an associated current feed.

The polymer or polymers constituting the base of the varnish (VEA) are especially chosen from acrylic polymers, siloxanes and silicones.

The electroactive organic compound or compounds (ea₁⁺) may be chosen from bipyridiniums or viologens such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymeric derivatives of the electroactive compounds which have just been mentioned; and the electroactive organic compound or compounds (ea₂) is or are chosen from metallocenes, such as cobaltocenes, ferrocenes, N,N,N′,N′-tetramethylphenylenediamine (TMPD), phenothiazines such as phenothiazine, dihydrophenazines such as 5,10-dihydro-5,10-dimethylphenazine, reduced methylphenothiazone (MPT), methylene violet bernthsen (MVB), verdazyls, and also all the electroactive polymer derivatives of the electroactive compounds which have just been mentioned.

The ionic charges may be borne by at least one ionic salt present within the varnish layer, the ionic salt or salts being chosen, in particular, from lithium perchlorate, trifluoromethanesulfonate or triflate salts, trifluoromethanesulfonylimide salts and ammonium salts.

The layer of varnish (VEA) has, in particular, a thickness at most equal to 100 μm.

An electronically conductive layer (TCC₁; TCC₂) may be a layer of metallic type, chosen, in particular, from layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:S₆), of fluorine-doped tin oxide (SnO₂:F) and of aluminum-doped zinc oxide (ZnO:Al); or multilayers of the TCO/metal/TCO type, the TCO and the metal being chosen, in particular, from those listed above; or multilayers of the NiCr/metal/NiCr type, the metal being chosen, in particular, from those listed above.

The TCC₁ layer may also be in the form of a grid or a microgrid. It may also comprise an organic and/or inorganic underlayer, especially in the case of plastic substrates, as described in international application WO 2007/057605.

An organic varnish layer and/or an inorganic layer or stack of layers may be deposited on the second electronically conductive layer (TCC₂) in order to protect the electrically controllable device from mechanical stresses such as scratches or chemical attacks due, for example, to oxygen or moisture from the ambient air. The organic varnish for protection of the TTC₂ may be siloxane-based and the inorganic layer or the stack of inorganic layers may be based on Si₃N₄ or on SiOₓ for example. Organic varnish/organic layer composite stacks may also be used.

The substrate having a glass function (V₁) may be chosen from glass and transparent polymers such as polymethyl methacrylate (PMMA), polycarbonate (PC), polyethylene terephthalate (PET), polyethylene naphthoate (PEN) and cycloolefin copolymers (COCs). The substrate (V₁) may therefore, without drawback, be a flexible substrate, such as PET.

The substrate having a glass function (V₁), positioned on the exterior side of the glazing, may be a toughened glass or else a laminated glass, the latter being constituted by two sheets of glass (V₁ₐ) and (V_{1b}) separated by a lamination interlayer sheet (I), for example a sheet of polyvinyl butyral (PVB) or a sheet of ethylene/vinyl acetate copolymer (EVA).

The electrically controllable device of the invention may be configured in order to form: a sunroof for a motor vehicle, that can be activated autonomously, or a side window or a rear window for a motor vehicle or a rearview mirror; a windshield or a portion of a windshield of a motor vehicle, of an aircraft or of a ship, a vehicle sunroof; an aircraft cabin window; a display panel for displaying graphical and/or alphanumeric information; an interior or exterior glazing unit for buildings; a skylight; a display cabinet or store counter; a glazing unit for protecting an object of the painting type; an anti-glare computer screen; glass furniture; and a wall for separating two rooms inside a building.

The electrically controllable device of the invention may be assembled as double glazing, a second substrate having a glass function (V₂) being added on the side of the second electronically conductive layer (TCC₂) with interposition of a gas-filled space, such as a space filled with air or argon, between it and said second electronically conductive layer (TCC₂).

Another subject of the present invention is a process for manufacturing an electrically controllable device as defined above, characterized in that deposited on a substrate having a glass function (V₁; V₁ₐ-I-V_{1b}) coated with a first electronically conductive layer (TCC₁) on the side of the latter, is a layer of electroactive varnish (VEA) based on at least one binder polymer containing:
at least one electroactive organic compound (ea₁⁺) capable of being reduced and/or of accepting electrons and cations acting as compensation charges;
at least one electroactive organic compound (ea₂) capable of being oxidized and/or of ejecting electrons and cations acting as compensation charges; at least one of said electroactive organic compounds (ea₁⁺ & ea₂) being electrochromic in order to obtain a color contrast; and
ionic charges capable of allowing, under an electric current, oxidation and reduction reactions of said electroactive organic compounds (ea₁⁺ & ea₂), which reactions are necessary to obtain the color contrast;
   then, after drying the varnish (VEA), a second electronically conductive layer (TCC₂),
   then, in the case where it is desired to produce a double glazing unit, a second substrate having a glass function (V₂) is added on the side of the second electronically conductive layer (TCC₂) with interposition of a gas-filled space, such as a space filled with air or argon, between it and said second electronically conductive layer (TCC₂).

The varnish layer (VEA) may advantageously be deposited by sprinkling, spraycoating or flowcoating, by screenprinting or by a spin-on deposition or spincoating technique or by an ink-jet type technique.

The second electronically conductive layer TCC₂ may advantageously be deposited by magnetron plasma-enhanced chemical vapor deposition (PE-CVD).

In order to better illustrate the subject of the present invention, two particular embodiments will be described in greater detail hereinbelow, with reference to the appended drawing.

In this drawing:

FIG. 1 is a schematic cross-sectional view of a portion of a double glazing unit for a building incorporating the electrically controllable device in its conventional configuration;

FIG. 2 is a view analogous to FIG. 1 but in a configuration of the invention; and

FIG. 3 is a view analogous to FIG. 2 but showing a variant of the configuration of the invention.

### EXEMPLARY EMBODIMENT

The “K-glass™” glass used in these examples is a glass covered with an electroconductive layer of SnO₂:F (glass sold under this name by “Pilkington”).

An electroactive varnish formulation was prepared by mixing 0.25 g of 5,10-dihydro-5,10-dimethylphenazine, 0.50 g of 1,1′-diethyl-4,4′-bipyridinium diperchlorate and 0.47 g of lithium triflate and 20 ml of SILIKOPHENE®P50/X resin, commercially available from Evonik Tego Chemie GmbH, in 20 ml of propylene carbonate. The solution was stirred for 1 hour.

A constant thickness of 60 μm of the electroactive varnish formulation was then cast on a K-glass™ glass using a film applicator. The solvent was evaporated by heating the K-glass™ glass covered with the electroactive resin formulation for 10 hours at 90° C.

Before depositing a layer of ITO by magnetron sputtering, the areas of SnO₂:F that were not covered with varnish, on the substrate covered with electroactive varnish, were masked. A 300 nm layer of ITO was then deposited by magnetron sputtering on the K-glass™ glass covered with electroactive varnish.

1. An electrically controllable device having variable optical/energy properties, comprising a stack of layers comprising:
(A) a substrate having a glass function;
(B) a first electronically conductive layer with an associated current feed;
(C) a layer of electroactive varnish comprising at least one binder polymer comprising constituents of an electroactive medium comprising:
at least one electroactive organic compound, ea₁⁺, capable of at least one of being reduced and accepting electrons and cations acting as compensation charges;
at least one electroactive organic compound, ea₂, capable of at least one of being oxidized and ejecting electrons and cations acting as compensation charges;
wherein at least one of the electroactive organic compounds, ea₁⁺ and ea₂, is electrochromic in order to obtain a color contrast; and
ionic charges capable of allowing, under an electric current, oxidation and reduction reactions of the electroactive organic compounds, ea₁⁺ & ea₂, necessary to obtain the color contrast, and
(D) a second electronically conductive layer with an associated current feed.

2. The device of claim 1, wherein the binder polymer constituting a base of the varnish is at least one selected from the group consisting of an acrylic polymer, a siloxane, and a silicone.

3. The device of claim 1, wherein the at least one electroactive organic compound, ea₁⁺, is selected from the group consisting of a bipyridinium, a viologen, a pyrazinium, a pyrimidinium, a quinoxalinium, a pyrylium, a pyridinium, a tetrazolium, a verdazyl, a quinone, a quinodimethane, a tricyanovinylbenzene, a tetracyanoethylene, a polysulfide, a disulfide, and an electroactive polymeric derivative thereof; and
the at least one electroactive organic compound, ea₂, is selected from the group consisting of a metallocene, N,N,N′,N′-tetramethylphenylenediamine (TMPD), a phenothiazine a dihydrophenazine, reduced methylphenothiazone (MPT), methylene violet bernthsen (MVB), a verdazyl, and an electroactive polymer derivative thereof.

4. The device of claim 1, wherein the ionic charges are borne by at least one ionic salt present within the varnish layer.

5. The device of claim 1, wherein the varnish layer has a thickness at most equal to 100 μm.

6. The device of claim 1, wherein at least one of the first and the second electronically conductive layer is a metallic layer, transparent conductive oxide (TCO) layer, a TCO/metal/TCO multilayer, or an NiCr/metal/NiCr multilayer.

7. The device of claim 1, wherein the first electronically conductive layer is in the form of a grid or a microgrid.

8. The device of claim 1, wherein the first electronically conductive layer comprises an organic underlayer, an inorganic underlayer, or an organic and inorganic underlayer.

9. The device of claim 1, wherein at least one selected from the group consisting of an organic varnish layer and an inorganic varnish layer is deposited on the second electronically conductive layer.

10. The device of claim 1, wherein the substrate having a glass function is glass or at least one transparent polymer.

11. The device of claim 10, wherein the substrate having a glass function, is positioned on an exterior side of a glazing, and is a toughened glass or a laminated glass, wherein the laminated glass comprises two sheets of glass separated by a lamination interlayer sheet.

12. The device of claim 10, wherein the substrate having a glass function is a flexible substrate.

13. The device of claim 1, in the form of:
a vehicle sunroof, a sunroof for a motor vehicle, that can be activated autonomously, a side window or a rear window for a motor vehicle, or a rearview mirror;
a windshield or a portion of a windshield of a motor vehicle, of an aircraft, or of a ship;
an aircraft cabin window;
a display panel for displaying at least one of graphical information and alphanumeric information;
an interior or exterior glazing unit for a building;
a skylight;
a display cabinet or store counter;
a glazing unit for protecting an image-bearing or painted object;
an anti-glare computer screen;
glass furniture; or
a wall for separating two rooms inside a building.

14. The device of claim 1, assembled as double glazing, wherein a second substrate having a glass function is added on a side of a varnished layer with interposition of a gas-filled space, between the second substrate and the varnish layer.

15. A process for manufacturing the device of claim 1, comprising
depositing on the substrate having a glass function coated with the first electronically conductive layer on a side of the substrate, a layer of the electroactive varnish comprising the at least one binder polymer;
then, after drying the varnish, adding the second electronically conductive layer;
then, where it is desired to produce a double glazing unit, adding a second substrate having a glass function on a side of the second electronically conductive layer after interposing a gas-filled space, between the varnish and the second electronically conductive layer.

16. The process of claim 15, wherein the varnish layer is deposited by sprinkling, spraycoating, flowcoating, screenprinting, spin-on deposition, spincoating, by ink-jet, and
wherein the second electronically conductive layer is deposited by magnetron plasma-enhanced chemical vapor deposition (PE-CVD).

17. The device of claim 3, wherein the at least one electroactive organic compound, ea₂, is selected from the group consisting of a cobaltocene, a ferrocene, phenothiazin, 5,10-dihydro-5,10-dimethylphenazine, and an electroactive polymer derivative thereof.

18. The device of claim 4, wherein the ionic salt present within the varnish layer is at least one selected from the group consisting of a lithium perchlorate salt, a trifluoromethanesulfonate salt, a triflate salt, a trifluoromethanesulfonylimide salt, and an ammonium salt.

19. The device of claim 5, wherein at least one of the first and the second electronically conductive layer is at least one metallic layer selected from the group consisting of a silver layer, a gold layer, a platinum layer, and a copper layer.

20. The device of claim 5, wherein at least one of the first and the second electronically conductive layer is at least one transparent conductive oxide layer selected from the group consisting of a tin-doped indium oxide (In₂O₃:Sn or ITO) layer, an antimony-doped indium oxide (In₂O₃:S₆) layer, a fluorine-doped tin oxide (SnO₂:F) layer, and an aluminum-doped zinc oxide (ZnO:Al) layer.
